(19) United States
(12) Patent Application Publication
(10) Pub. No.: US 2002/0157260 A1
(43) Pub. Date: Oct. 31, 2002

(54) Retractable knife with safety device

(76) Inventor: Yang-Fu Cheng, Taipei (TW)

Correspondence Address: BACON & THOMAS, PLLC, 4th Floor, 625 Slaters Lane, Alexandria, VA, 22314-1176, US

(21) Appl. No.: 09/843,800

(22) Filed: Apr. 30, 2001

(51) Int. Cl. B26B 1/04

(52) U.S. Cl. 30/161; 30/155

(57) ABSTRACT

A retractable knife with a safety device to prevent the knife from being inadvertently extended once retracted, the knife comprises a blade having a first and second grooves on the opposite sides of the blade; a flat handle means including a first handle and a second handle with the blade pivotally disposed at and between the front ends of the first and the second handles in a first position for forming a receiving space; and a safety button having an arc member disposed at and between a second position on the first and the second handles adjacent to the first position. The safety button is operative to either insert the arc member into the first groove in an extended position of the blade or the second groove in the retracted position of the blade, thus locking the blade in the either positions.

### FIELD OF THE INVENTION

The present invention relates to retractable knifes and more particularly to a retractable knife with safety device for preventing from being inadvertently extended.

### BACKGROUND OF THE INVENTION

A conventional retractable knife comprises a flat handle, a blade pivotally disposed at the front end of handle, blade having one flat side and the other cutting side, and an elastic member on handle wherein the elastic member is depressible by finger for receiving the blade and one end of elastic member is urged against the rear end of blade for securing blade when blade is extended. However, the previous design suffered from a disadvantage. In brief, a retracted blade is subject to extend accidentally for example when a child manipulates it for fun. As a result, people may get hurt by the extended blade.

### SUMMARY OF THE INVENTION

It is thus an object of the present invention to provide a retractable knife with a safety device to prevent the knife from being inadvertently extended once retracted, the knife comprises a blade having a first and second grooves on the opposite sides of the blade; a flat handle means including a first handle and a second handle with the blade pivotally disposed at and between the front ends of the first and the second handles in a first position for forming a receiving space; and a safety button having an arc member pivotally disposed at and between a second position on the first and the second handles adjacent to the first position. The safety button is operative to either insert the arc member into the first groove in an extended position of the blade or the second groove in the retracted position of the blade, thus locking the blade in the either positions.

The above and other objects, features and advantages of the present invention will become apparent from the following detailed description taken with the accompanying drawings.

### BRIEF DESCRIPTION OF THE DRAWINGS

FIG. 1 is an exploded view of a first preferred embodiment of retractable knife according to the invention;

FIG. 2 is a plan view of the FIG. 1 assembled knife where blade is extended;

FIG. 3 is similar to FIG. 2 where blade is received in handle;

FIG. 4 is a plan view of a second preferred embodiment of retractable knife according to the invention where blade is received in handle;

FIG. 5 is a plan view of a third preferred embodiment of retractable knife according to the invention where blade is extended; and

FIG. 6 is a plan view of a fourth preferred embodiment of retractable knife according to the invention where blade is extended.

### DETAILED DESCRIPTION OF THE PREFERRED EMBODIMENTS

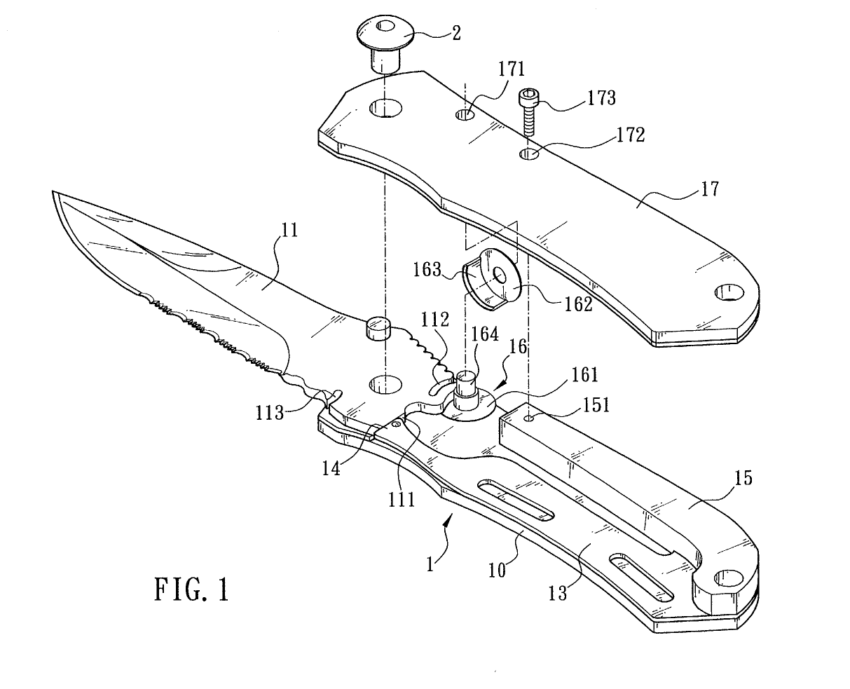

Referring to FIG. 1, there is shown a retractable knife 1 constructed in accordance with the invention comprising a flat first handle 10, a blade 11 pivotally disposed at the front end of first handle 10, an elastic member 13 on one side of first handle 10, an abutment member 15 on the opposite side making part of elastic member 13 being sandwiched between abutment member 15 and first handle 10 and secured on the rear end of first handle 10, the front end of elastic member 13 being curved upwardly to space from the front end of first handle 10 so as to configure as an elastic means, elastic member 13 having a stopper edge 14 on the front end urged against the rear edge 111 of blade 11 when blade 11 is extended for securing blade 11 in place, a safety button 16 adjacent to the front end of abutment member 15, safety button 16 having a cylindrical shape and including a first member 161 having a projected shaft 164 and a second member 162 having an arc member 163 on the periphery wherein second member 162 is put on and pivotally disposed on the shaft 164 and the top and bottom ends of the shaft 164 are pivotally received in first hole 171 of second handle 17 and first handle 10 respectively, a first and second grooves 112 and 113 formed on opposite sides of blade 11 respectively, a second handle 17 having a second hole 172 near center, a fastening member 173 (e.g., screw as shown but it may be replaced by another suitable fastening member in other embodiments) driven through second hole 172 and third hole 151 of abutment member 15 for securing first and second handles 10 and 17 together, and a rivet 2 for pivotally securing first handle 10, blade 11, and second handle 17 together.

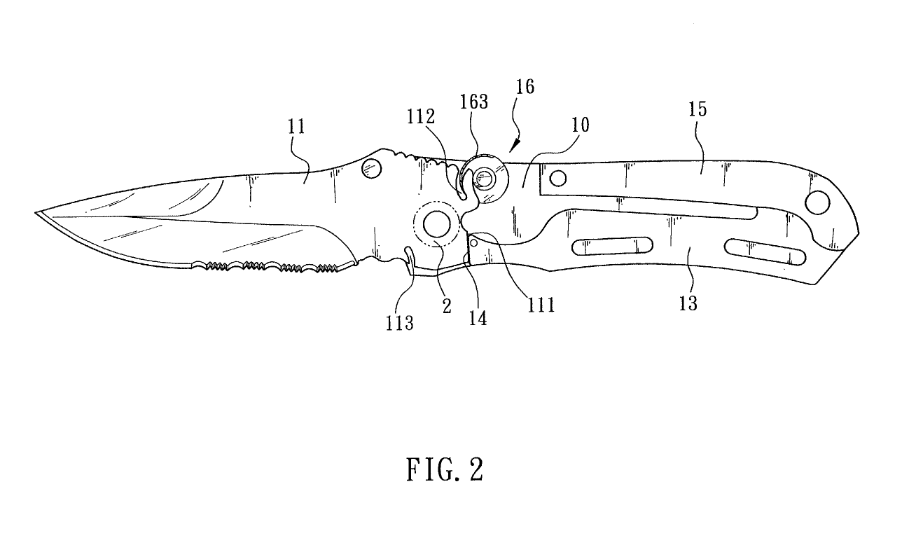

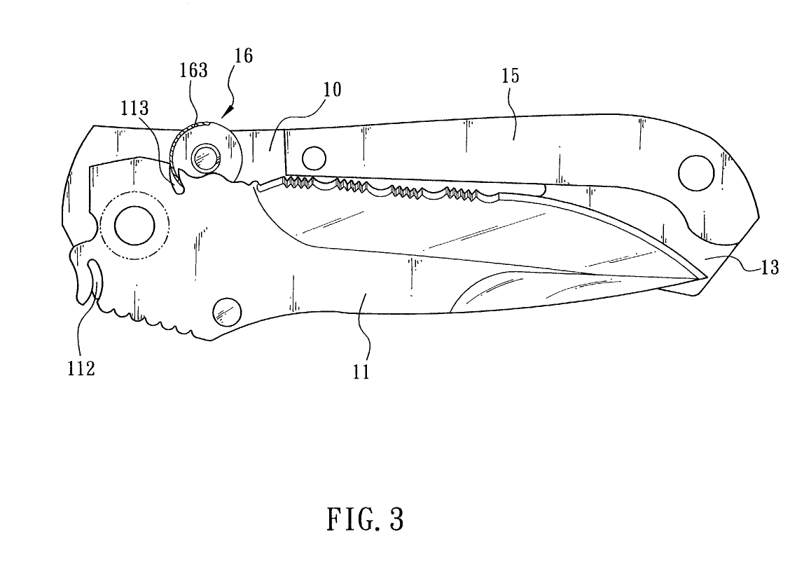

Referring to FIGS. 2 and 3, the operation of the retractable knife 1 is detailed below. In FIG. 2 where knife 1 is extended, the rear edge 111 of blade 11 has one portion urged against the shaft 164 of safety button 16 and another portion urged against the stopper edge 14 of elastic member 13. Further, rotate safety button 16 clockwise to insert arc member 163 into first groove 112 on the back of blade 11, thus locking blade 11 in the extended position. In comparison as shown in FIG. 3 where blade 11 has been retracted. Then rotate safety button 16 clockwise to insert arc member 163 into second groove 113 on the cutting edge of blade 11, thus locking blade 11 in the retracted position. This safe mechanism thus can prevent a retracted knife 1 from inadvertently being extended.

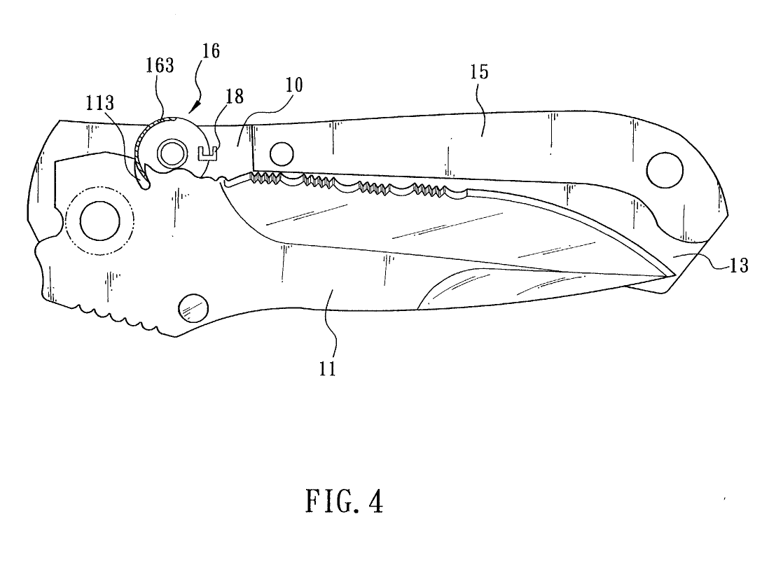

Referring to FIG. 4, there is shown a second preferred embodiment of retractable knife according to the invention. The differences between first and second embodiments are detailed as follows: there is only second groove 113 provided on the cutting edge of blade 11 and there is a stopper member 18 provided on the outer side of safety button 16 to prevent it from being counterclockwise rotated over stopper member 18. Once blade 11 is retracted into handle, safety button 16 may be clockwise rotated to insert arc member 163 into second groove 113, thus locking blade 11 in the retracted position.

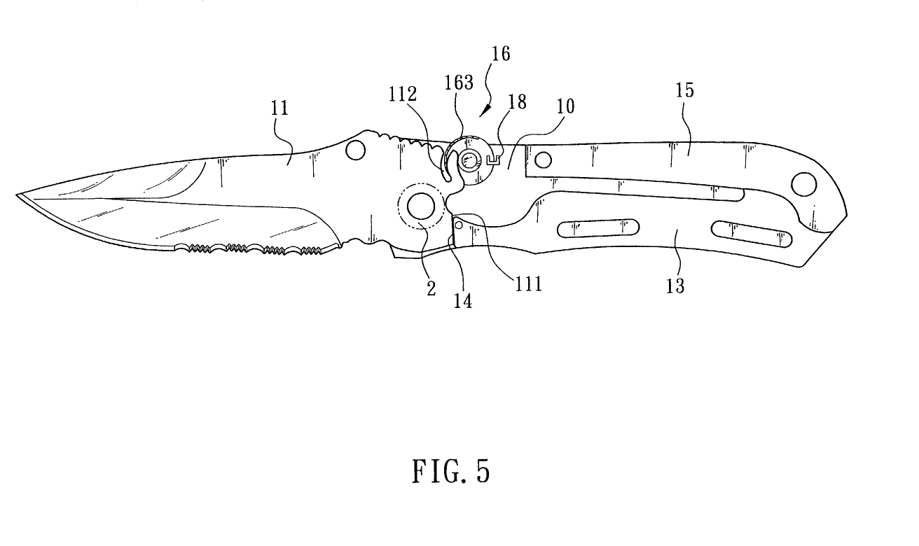

Referring to FIG. 5, there is shown a third preferred embodiment of retractable knife according to the invention. The differences between second and third embodiments are detailed as follows: there is only first groove 112 provided on the back of blade 11. Once blade 11 is retracted into handle, safety button 16 may be clockwise rotated to insert arc member 163 into first groove 112, thus locking blade 11 in the retracted position.

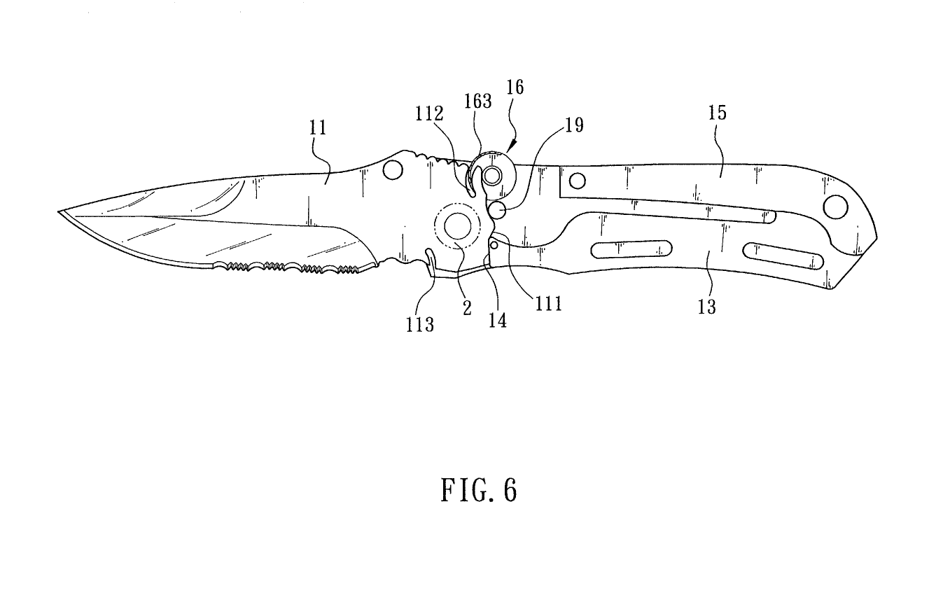

Referring to FIG. 6, there is shown a fourth preferred embodiment of retractable knife according to the invention. The differences between third and fourth embodiments are detailed as follows: there is a post 19 provided in contact with the periphery of safety button 16. In the extended position of blade 1, the rear edge 111 of blade 11 has one portion urged against the post 19 and another portion urged against the stopper edge 14 of elastic member 13. Further, rotate safety button 16 clockwise to insert arc member 163 into first groove 112 on the back of blade 11, thus locking blade 11 in the extended position.

While the invention has been described by means of specific embodiments, numerous modifications and variations could be made thereto by those skilled in the art without departing from the scope and spirit of the invention set forth in the claims.

What is claimed is:

1. A retractable knife with a safety device to prevent said knife from being inadvertently extended once retracted, said knife comprising:
a blade having a groove means;
a flat handle means including a first handle and a second handle with said blade pivotally disposed at and between front ends of said first and said second handles in a first position for forming a receiving space; and
a safety button pivotally disposed at and between a second position on said first and said second handles adjacent to said first position;
wherein, in a retracted position of said blade, said safety button is operative to rotate to insert into said groove means, thus locking said blade in said retracted position.

2. The retractable knife of claim 1, wherein said groove means comprises a first groove and a second groove on opposite sides of said blade such that said safety button is operative to either insert into said first groove in an extended position of said blade or said second groove in said retracted position of said blade.

3. The retractable knife of claim 1, further comprising a first hole on said first handle and second handle respectively, an abutment member having a second hole, and a fastening member driven through said first and said second holes for securing said first and said second handles together.

4. The retractable knife of claim 3, wherein said fastening member is a screw.

5. The retractable knife of claim 4, further comprising an elastic member on said receiving space and sandwiched between said abutment member and said first handle, and secured on rear end of said first handle, front end of said elastic member being curved upwardly to space from front end of said first handle so as to configure as an elastic means, and having a stopper edge on front end urged against rear edge of said blade when said blade is extended for securing said blade in place.

6. The retractable knife of claim 5, wherein said safety button comprises a through shaft having top and bottom ends thereof pivotally received in said second handle and said first handle respectively.

7. The retractable knife of claim 6, further comprising a rivet for pivotally securing said first handle, said blade, and said second handle together.

8. The retractable knife of claim 7, further comprising a stopper member on outer side of said safety button such that said safety button is operative to rotate in one direction.

9. The retractable knife of claim 8, further comprising a slot on cutting edge of said blade and a stopper member on outer side of said safety button having an arc member on periphery such that when said blade is extended, said safety button is operative to rotate and insert said arc member into said slot, thereby locking said blade in said extended position.

10. The retractable knife of claim 1, further comprising a post in contact with said periphery of said safety button such that when said blade is extended, a first portion of said rear edge of said blade is urged against said post and a second portion thereof is urged against said stopper edge of said elastic member, thereby securing said blade in said extended position.
